(19) United States
(12) Patent Application Publication
(10) Pub. No.: US 2017/0248807 A1
(43) Pub. Date: Aug. 31, 2017

(54) ELECTRO-OPTICAL PHASE MODULATION SYSTEM

(71) Applicant: NATIONAL TIME SERVICE CENTER, CHINESE ACADEMY OF SCIENCE, XI'AN (CN)

(72) Inventors: HAIFENG JIANG, XI'AN (CN); ZHAOYANG TAI, XI'AN (CN); YANYAN ZHANG, XI'AN (CN); LONG ZHANG, XI'AN (CN); LULU YAN, XI'AN (CN); WENYU ZHAO, XI'AN (CN); SHOUGANG ZHANG, XI'AN (CN)

(21) Appl. No.: 15/590,923

(22) Filed: May 9, 2017

Related U.S. Application Data
(63) Continuation of application No. PCT/CN2016/070552, filed on Jan. 11, 2016.

(51) Int. Cl. G02F 1/03

(52) U.S. Cl. CPC G02F 1/0344; G02F 1/0316; G02F 1/0311; G02F 1/0327; G02F 2203/07; G02F 2202/20

(57) ABSTRACT

Provided is an electro-optical phase modulation system, including: an electro-optical crystal, a radio frequency circuit and a light source, light incident surface of the electro-optical crystal is in parallel with light exit surface, upper electrode surface thereof is in parallel with lower electrode surface, and an angle between light incident surface and upper electrode surface is Brewster angle; two electrodes of radio frequency circuit are connected to upper and lower electrode surfaces respectively, for transmitting radio frequency signals to upper and lower electrode surfaces, so that an electric filed, direction of which is perpendicular to upper electrode surface, is formed between upper and lower electrode surfaces; light source is located at a side of light incident surface, and incidence angle of beams from light source with respect to light incident surface is Brewster angle. The system is used to reduce residual amplitude modulation, and increase accuracy of phase modulation.

### CROSS-REFERENCE TO RELATED APPLICATIONS

This application is a continuation of International Application No. PCT/CN2016/070552, filed on Jan. 11, 2016, the disclosure of which is hereby incorporated by reference in its entirety.

### TECHNICAL FIELD

Embodiments of the present invention relate to the field of laser control technologies and, in particular, to an electro-optical phase modulation system.

### BACKGROUND

Since electro-optical phase modulation technologies have relatively high sensitivity, the electro-optical phase modulation technologies have been widely used in technical fields such as atomic spectra and ultra-stable laser. Currently, electro-optical phase modulation is generally achieved through an electro-optical phase modulator, and a key component of the electro-optical phase modulator is an electro-optical crystal.

Currently, the electro-optical phase modulation is divided into transverse electro-optical phase modulation and longitudinal electro-optical phase modulation. In the transverse electro-optical phase modulation, it is needed to ensure that the direction of an electric filed is perpendicular to the direction of beams inside the electro-optical crystal, which is generally achieved by the following manner: transmitting radio frequency signals on an upper surface and a lower surface of the cuboid-shaped electro-optical crystal via a radio frequency circuit, so that an electric filed, of which the direction is perpendicular to the upper surface, is formed between the upper surface and the lower surface; and then enabling beams emitted from a light source to enter the inside of the electro-optical crystal in a direction perpendicular to a light incident surface, so that the direction of the beams entering the inside of the electro-optical crystal is perpendicular to the direction of the electric field. In the above manner, when the beams arrive at a light exit surface (in parallel with the light incident surface), the light exit surface will reflect the beams, and reflect the beams onto the light incident surface; the light incident surface will reflect the received reflection beams again, causing the beams inside the electro-optical crystal to be reflected back and forth between the light incident surface and the light exit surface, thereby resulting in residual amplitude modulation. Meanwhile, another important effect causing the residual amplitude modulation is a polarization rotation effect, that is, light of different polarizations in a beam of light undergoes different modulations in the electro-optical crystal and then causes the polarization rotation, the polarization-rotating light then passes through a polarizer behind the electro-optical crystal and causes the residual amplitude modulation, which cannot be avoided in a traditional modulator. The residual amplitude modulation will have a negative impact on accuracy of phase modulation. Moreover, the higher the residual amplitude modulation, the greater the impact on the accuracy of phase modulation.

In the prior art, in order to reduce the residual amplitude modulation, anti-reflective films are usually coated on the light incident surface and the light exit surface of the electro-optical crystal, which aims to reduce back-and-forth reflection of the beams between the light incident surface and the light exit surface via the anti-reflective films. However, the back-and-forth reflection of the beams between the light incident surface and the light exit surface cannot be completely avoided via the anti-reflective films, so that the beams are still reflected back and forth between the light incident surface and the light exit surface, thereby resulting in the residual amplitude modulation, and affecting the accuracy of phase modulation.

### SUMMARY

Embodiments of the present invention provide an electro-optical phase modulation system, which aims to reduce residual amplitude modulation, and then increase accuracy of the phase modulation.

Embodiments of the present invention provide an electro-optical phase modulation system, including: an electro-optical crystal, a radio frequency circuit and a light source, where,

a light incident surface of the electro-optical crystal is in parallel with a light exit surface thereof, an upper electrode surface of the electro-optical crystal is in parallel with and facing a lower electrode surface thereof, the light incident surface and the light exit surface are located between the upper electrode surface and the lower electrode surface, and an angle between the light incident surface and the upper electrode surface is a Brewster angle;

two electrodes of the radio frequency circuit are connected to the upper electrode surface and the lower electrode surface respectively, for transmitting radio frequency signals to the upper electrode surface and the lower electrode surface, so that an electric filed, of which a direction is perpendicular to the upper electrode surface, is formed between the upper electrode surface and the lower electrode surface;

the light source is located at a side of the light incident surface, and an incidence angle of a beam emitted from the light source with respect to the light incident surface is the Brewster angle.

Embodiments of the present invention provide an electro-optical phase modulation system, including: an electro-optical crystal, a radio frequency circuit and a light source, where, a light incident surface of the electro-optical crystal is in parallel with a light exit surface thereof, an upper electrode surface of the electro-optical crystal is in parallel with and facing a lower electrode surface thereof, the light incident surface and the light exit surface are located between the upper electrode surface and the lower electrode surface, and an angle between the light incident surface and the upper electrode surface is a Brewster angle; two electrodes of the radio frequency circuit are connected to the upper electrode surface and the lower electrode surface respectively, for transmitting radio frequency signals to the upper electrode surface and the lower electrode surface, so that an electric filed, of which the direction is perpendicular to the upper electrode surface, is formed between the upper electrode surface and the lower electrode surface; the light source is located at a side of the light incident surface, and an incidence angle of a beam emitted from the light source with respect to the light incident surface is the Brewster angle. In this electro-optical phase modulation system, since the incidence angle when the beams enter the electro-optical crystal is the Brewster angle, and the angle between the light incident surface and the upper electrode surface is the Brewster angle, refracted light entering the electro-optical crystal is in parallel with the upper electrode surface of the electro-optical crystal, so that the direction of the refracted light is perpendicular to the direction of the electric field in the electro-optical crystal, satisfying conditions of transverse electro-optical modulation. Further, an angle between the refracted light in the electro-optical crystal and the light exit surface is the Brewster angle (a non-right angle), thus, a small amount of beams which are reflected on the light exit surface will not be reflected onto the light incident surface, which prevents the beams from being reflected back and forth between the light incident surface and the light exit surface, thereby effectively reducing residual amplitude modulation, and increasing accuracy of the phase modulation.

### BRIEF DESCRIPTION OF DRAWINGS

In order to make technical solutions in embodiments of the present invention or the prior art more clearly, accompanying drawings used for description of the embodiments of the present invention or the prior art will be briefly described hereunder. Obviously, the described drawings are merely some embodiments of the present invention. For persons skilled in the art, other drawings may be obtained based on these drawings without any creative effort.

FIG. 1 is a first schematic structural diagram of an electro-optical phase modulation system according to the present invention;

FIG. 2 is a first schematic diagram of a beam transmission process according to the present invention;

FIG. 3 is a second schematic structural diagram of an electro-optical phase modulation system according to the present invention;

FIG. 4 is a second schematic diagram of a beam transmission process according to the present invention; and

FIG. 5 is a schematic structural diagram of a system for detecting residual amplitude modulation according to the present invention.

### DESCRIPTION OF EMBODIMENTS

In order to make objectives, technical solutions, and advantages of embodiments of the present invention more clearly, the technical solutions in the embodiments of the present invention will be described hereunder with reference to the accompanying drawings in the embodiments of the present invention. Obviously, the described embodiments are only a part of embodiments of the present invention, rather than all embodiments of the present invention. All other embodiments obtained by persons of ordinary skill in the art based on the embodiments of the present invention without any creative effort shall fall into the protection scope of the present invention.

The electro-optical phase modulation system involved in embodiments of the present invention is applied in transverse electro-optical phase modulation, and the electro-optical phase modulation system could perform modulation on a phase of a beam. The electro-optical phase modulation system provided in the present invention aims to solve a problem in the prior art that accuracy of phase modulation is affected due to generation of relatively large residual amplitude modulation during an electro-optical phase modulation process. The electro-optical phase modulation system will be described hereunder in detail through specific embodiments.

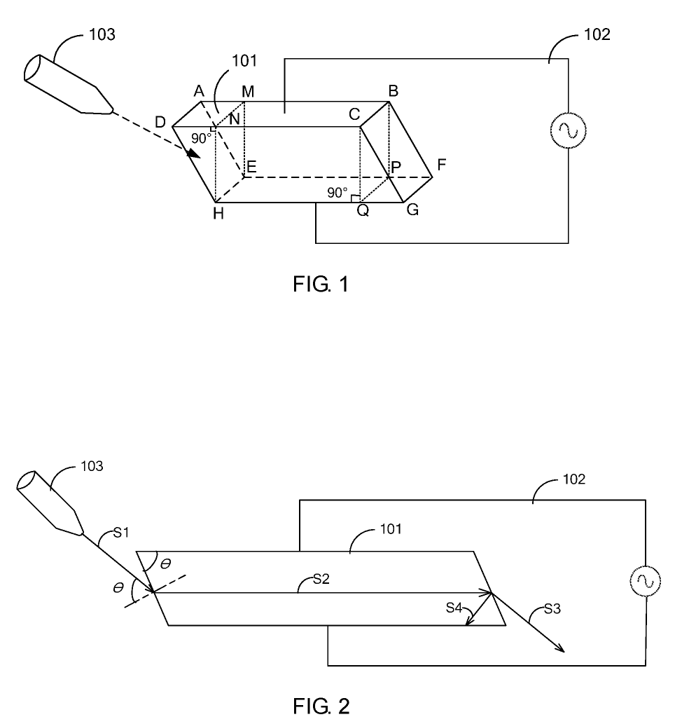

FIG. 1 is a first schematic structural diagram of an electro-optical phase modulation system according to the present invention; reference may be made to FIG. 1, the system can include: an electro-optical crystal 101, a radio frequency circuit 102 and a light source 103.

A light incident surface ADHE of the electro-optical crystal 101 is in parallel with a light exit surface BFGC thereof, an upper electrode surface MBCN of the electro-optical crystal is in parallel with and facing a lower electrode surface EPQH thereof, the light incident surface ADHE and the light exit surface BFGC are located between the upper electrode surface MBCN and the lower electrode surface EPQH, and an angle between the light incident surface ADHE and the upper electrode surface MBCN is a Brewster angle.

Two electrodes of the radio frequency circuit 102 are connected to the upper electrode surface MBCN and the lower electrode surface EPQH respectively, which are used to transmit radio frequency signals to the upper electrode surface MBCN and the lower electrode surface EPQH, so that an electric filed, of which the direction is perpendicular to the upper electrode surface, is formed between the upper electrode surface MBCN and the lower electrode surface EPQH.

The light source 103 is located at a side of the light incident surface, and an incidence angle of a beam emitted from the light source with respect to the light incident surface is the Brewster angle.

The Brewster angle is associated with a wavelength of the beam emitted from the light source and a property (such as a refractive index) of the electro-optical crystal. When the light source is fixed (i.e., the beam emitted from the light source has a fixed wavelength) and the electro-optical crystal is fixed, the Brewster angle is a fixed angle; further, in order to facilitate production and processing of the electro-optical crystal, a first cross section CGHD of the electro-optical crystal is in parallel with a second cross section BFEA thereof, the first cross section CGHD and the second cross section BFEA are located between the upper electrode surface MBCN and the lower electrode surface EPQH and between the light incident surface ADHE and the light exit surface BFGC, the first cross section CGHD is perpendicular to the upper electrode surface MBCN, and the first cross section CGHD is perpendicular to the light incident surface ADHE.

In embodiments of the present invention, the upper electrode surface MBCN is in parallel with and facing the lower electrode surface EPQH, which ensures that the electric field between the upper electrode surface MBCN and the lower electrode surface EPQH is completely perpendicular to the propagation direction of the beam, and that the light of different polarizations are separated.

In embodiments of the present invention, the light source may be a laser, and the electro-optical crystal may be one of a lithium niobate crystal, a magnesium-doped lithium niobate crystal and a potassium titanyl phosphate crystal. Certainly, during practical use, the electro-optical crystal may also be made from other materials, the present invention will not make a limitation thereto; further, in order to guarantee accuracy of the electro-optical phase modulation system, processing parameters of the electro-optical crystal may be as follows: the degree of parallelism of opposite surfaces is 0.02 mm, surface roughness is 0.012 μm, and light transmittance is 98%.

In embodiments of the present invention, the light incident surface ADHE of the electro-optical crystal is in parallel with the light exit surface BFGC, and the upper electrode surface MBCN of the electro-optical crystal is in parallel with the lower electrode surface EPQH, in this way, the light will not get an angular deflection after passing through the electro-optical crystal, that is, the exit light is in parallel with the incident light, which reduces sensitivity of the electro-optical crystal to vibration (the vibration changes the incidence angle) and temperature (the temperature changes the refractive index of the crystal) etc., and enhances anti-interference of the electro-optical crystal to the external environment, thereby enhancing anti-interference of the electro-optical modulator to the external environment.

Now an example in which an electro-optical crystal has a trapezoidal section is taken to show that an electro-optical crystal cut in other shapes has poor anti-interference to the external environment: for the electro-optical crystal having the trapezoidal section, the exit light of the light that needs to be modulated (for instance, extraordinary light e light) is no longer in parallel with the incident light, that is to say, an angular deflection occurs in optical paths of the exit light and the incident light, and this angular deflection will change into a huge positional deflection after the light passes through a long optical path, which has great impacts on the optical path. Meanwhile, the temperature will change the refractive index of the crystal, and thus a refractive angle will be changed, causing the exit light to get an angular deflection, thereby generating destructive effects the same as those the vibration brings.

Hereinafter, with reference to a beam transmission process in an electro-optical crystal as shown in FIG. 2, the electro-optical phase modulation system as shown in the embodiment of FIG. 1 will be described in detail.

FIG. 2 is a first schematic diagram of a beam transmission process according to the present invention, and the electro-optical crystal in FIG. 2 is the same as the electro-optical crystal in FIG. 1, for convenience of description, the electro-optical crystal in FIG. 2 is illustrated in a plane view.

After the radio frequency circuit 102 is electrified, an electric filed, of which the direction is perpendicular to the upper electrode surface, is formed between the upper electrode surface and the lower electrode surface of the electro-optical crystal 101; an incidence angle of the beam S1 emitted from the light source 103 with respect to the light incident surface is the Brewster angle θ; the beam S1 is refracted to produce the refracted light S2 after entering the electro-optical crystal. Since the angle between the light incident surface and the upper electrode surface is the Brewster angle, and the incidence angle of the beam S1 with respect to the light incident surface is the Brewster angle, the transmission direction of the refracted light S2 is in parallel with the upper electrode surface, so that the transmission direction of the refracted light S2 is perpendicular to the direction of the electric field between the upper electrode surface and the lower electrode surface, satisfying conditions of transverse electro-optical modulation.

When the refracted light S2 arrives at the light exit surface, a large portion of the refracted light S2 departs from the light exit surface to form exit light S3, and the exit light S3 is in parallel with the incident light S1; a small portion of the refracted light S2 is reflected on the light exit surface to form reflected light S4, since the angle between the refracted light S2 and the light exit surface is the Brewster angle, and the Brewster angle is a non-right angle, the reflected light S4 will not be reflected again onto the light incident surface, which prevents the beam from being reflected back and forth between the light incident surface and the light exit surface, thereby effectively reducing residual amplitude modulation. Meanwhile, in the above electro-optical phase modulation system, two linearly polarized beams, polarizations of which are perpendicular to each other, are separated, which prevents the two beams from interfering with each other to produce residual amplitude modulation. Further, in the electro-optical phase modulation system as shown in FIG. 1, there is no need to coat the light incident surface and the light exit surface of the electro-optical crystal with anti-reflective films, in this way, not only manufacturing costs are saved, it is also very helpful for elevation of a crystal laser damage threshold; further, it is also possible to make the electro-optical phase modulation system applicable to applications of a high power laser.

It is also to be noted that, the design of the Brewster angle in the present invention has a wider passable wavelength compared with a conventional anti-reflective film; it can also be said that, a crystal cut in the Brewster angle has a smaller insertion loss in a wider waveband and has greater transmittance than the crystal having the anti-reflective film. Therefore, the electro-optical modulator in the present invention is suitable for modulation of laser having a very large wavelength range; compared with a conventional modulator coated with an anti-reflective film which can only perform modulation to laser having a single wavelength or a wavelength range of several hundred nanometers, the modulator in the present invention, though designed for laser of 1555 nm, has an insertion loss less than 0.03% (a theoretical calculating value) in the 1000 nm-wide range around 1555 nm.

Embodiments of the present invention provide an electro-optical phase modulation system, including: an electro-optical crystal, a radio frequency circuit and a light source, where a light incident surface of the electro-optical crystal is in parallel with a light exit surface thereof, an upper electrode surface of the electro-optical crystal is in parallel with and facing a lower electrode surface thereof, the light incident surface and the light exit surface are located between the upper electrode surface and the lower electrode surface, and an angle between the light incident surface and the upper electrode surface is a Brewster angle; two electrodes of the radio frequency circuit are connected to the upper electrode surface and the lower electrode surface respectively, which are used to transmit radio frequency signals to the upper electrode surface and the lower electrode surface, so that an electric filed, of which the direction is perpendicular to the upper electrode surface, is formed between the upper electrode surface and the lower electrode surface; the light source is located at a side of the light incident surface, and an incidence angle of the beam emitted from the light source with respect to the light incident surface is the Brewster angle. In this electro-optical phase modulation system, since the incidence angle when beams enter the electro-optical crystal is the Brewster angle, and the angle between the light incident surface and the upper electrode surface is the Brewster angle, refracted light entering the electro-optical crystal is in parallel with the upper electrode surface of the electro-optical crystal, so that the direction of the refracted light is perpendicular to the direction of the electric field in the electro-optical crystal, satisfying conditions of transverse electro-optical modulation. Further, an angle between the refracted light in the electro-optical crystal and the light exit surface is the Brewster angle (a non-right angle), thus, a small amount of beams which are reflected on the light exit surface will not be reflected onto the light incident surface, which prevents the beams from being reflected back and forth between the light incident surface and the light exit surface, thereby effectively reducing residual amplitude modulation.

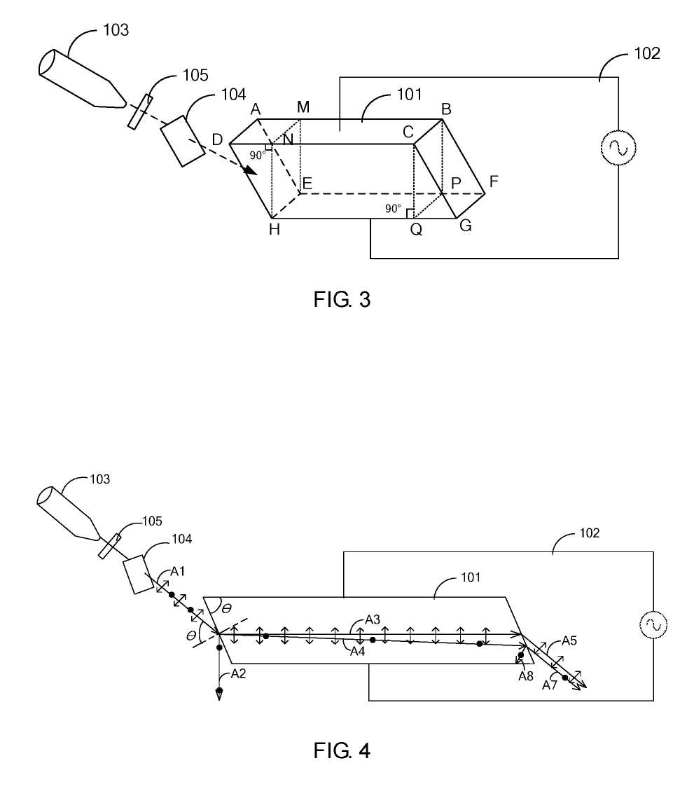

Based on the embodiment as shown in FIG. 1, in order to facilitate regulation performed by a user to the incidence angle of the beam emitted from the light source with respect to the light incident surface, an angle detecting apparatus can also be added in the electro-optical phase modulation system, specifically, reference may be made to an embodiment as shown in FIG. 3.

FIG. 3 is a second schematic structural diagram of an electro-optical phase modulation system according to the present invention. Based on the embodiment as shown in FIG. 1, reference may be made to FIG. 3; the system can also include an angle detecting apparatus 104.

The angle detecting apparatus 104 is configured to detect an incidence angle of the beam emitted from the light source with respect to the light incident surface, and display the angle, so that a user regulates a position of the light source or a position of the electro-optical crystal according to this angle and the Brewster angle.

Optionally, the angle detecting apparatus 104 can detect the incidence angle of the beam with respect to the light incident surface through the following feasible implementations: disposing the angle detecting apparatus between the light source and the light incident surface, and enabling the angle detecting apparatus to be in parallel with the light incident surface, where the angle detecting apparatus detects an incidence angle of the beam with respect to the angle detecting apparatus, and determines the incidence angle of the beam with respect to the angle detecting apparatus to be the incidence angle of the beam with respect to light incident surface. Optionally, the angle detecting apparatus may be provided with a display screen, through which the incidence angle of the beam with respect to the light incident surface is displayed; further, the Brewster angle can also be displayed on the display screen, so that the user more conveniently regulates the position of the light source or the position of the electro-optical crystal according to the incidence angle of the beam with respect to the light incident surface as well as the Brewster angle, to make the incidence angle of the beam emitted from the light source with respect to the light incident surface be the Brewster angle. It should be noted that, in the angle detecting apparatus, an area for transmitting beams may be a lens.

Further, the electro-optical phase modulation system can also include a polarizer 105, where the polarizer 105 is located between the light source 103 and the electro-optical crystal 101, and is configured to adjust the beam emitted from the light source into polarized light. Optionally, the polarizer 105 may be disposed between the light source 103 and the angle detecting apparatus 104, and the polarizer 105 may also be disposed between the angle detecting apparatus 104 and the light incident surface.

After the beam emitted from the light source passes through the polarizer, the beam is adjusted into linearly polarized light. The electro-optical phase modulation system as shown in the embodiment of FIG. 3 will be described hereunder in detail with reference to a transmission process of linearly polarized light in an electro-optical crystal as shown in FIG. 4.

FIG. 4 is a second schematic diagram of a beam transmission process according to the present invention, and the electro-optical crystal in FIG. 4 is the same as the electro-optical crystal in FIG. 3, for convenience of description, the electro-optical crystal in FIG. 4 is illustrated in a plane view.

The beam emitted from the light source 103 is adjusted into a linearly polarized beam after passing through the polarizer 105; the linearly polarized beam passes through the angle detecting apparatus 104; the angle detecting apparatus 104 detects and display an incidence angle of the linearly polarized beam with respect to the light incident surface; a user could regulate the position of the electro-optical crystal 101 or the position of the light source 103 according to the Brewster angle of the system and the angle detected by the angle detecting apparatus 104, till the incidence angle of the linearly polarized beam with respect to the light incident surface becomes the Brewster angle.

Assuming that the linearly polarized light passing through the angle detecting apparatus 104 is A1, the linearly polarized light A1 could be decomposed into two beams of linearly polarized light, polarizations of which are perpendicular to each other: the linearly polarized light in parallel with the upper electrode surface and the linearly polarized light perpendicular to the upper electrode surface. When the linearly polarized light A1 arrives at the light incident surface by taking the Brewster angle as the incidence angle, all the linearly polarized light perpendicular to the upper electrode surface enters the electro-optical crystal to obtain refracted light A3, and the refracted light A3 is in parallel with the upper electrode surface of the electro-optical crystal; when the refracted light A3 arrives at the light exit surface, a large amount of beams depart from the light exit surface to obtain exit light A5, and the exit light A5 is in parallel with the incident light A1. A large portion of the linearly polarized light in parallel with the upper electrode surface is reflected on the light incident surface to obtain reflected light A2, a small portion of the linearly polarized light in parallel with the upper electrode surface enters the electro-optical crystal to obtain refracted light A4, and the refracted light A4 is not in parallel with the upper electrode surface of the electro-optical crystal; when the refracted light A4 arrives at the light exit surface, a large amount of beams depart from the light exit surface to obtain exit light A7, a small amount of beams are reflected on the light exit surface to obtain reflected light A8, and the reflected light A8 will not be reflected onto the light incident surface directly. It can be seen from the above description that, two beams of light, polarizations of which are perpendicular to each other, can be separated, thereby reducing residual amplitude modulation.

In the above process, since the electro-optical crystal has different refractive indexes for different polarized light, when the linearly polarized light perpendicular to the upper electrode surface is transmitted inside the electro-optical crystal, that is, in parallel with the upper electrode surface, and when the linearly polarized light in parallel with the upper electrode surface is transmitted inside the electro-optical crystal, that is, not in parallel with the upper electrode surface, the linearly polarized light perpendicular to the upper electrode surface and the linearly polarized light in parallel with the upper electrode surface could be spatially separated, thereby effectively suppressing undesired polarized light from affecting desired polarized light, and also suppressing residual amplitude modulation resulting from birefringence of the crystal; meanwhile, the linearly polarized light perpendicular to the upper electrode surface (the desired polarized light) could pass through the electro-optical crystal without loss, and a large portion of the linearly polarized light in parallel with the upper electrode surface (the undesired polarized light) is reflected, this could also act on suppression of the residual amplitude modulation resulting from birefringence of the crystal.

During practical use, preferably, conducting films are coated on a first portion of the upper electrode surface and a second portion of the low electrode surface, respectively, and the first portion is aligned with the second portion, so that an electric field, of which the direction is perpendicular to the upper electrode surface, is formed between the upper electrode surface and the lower electrode surface.

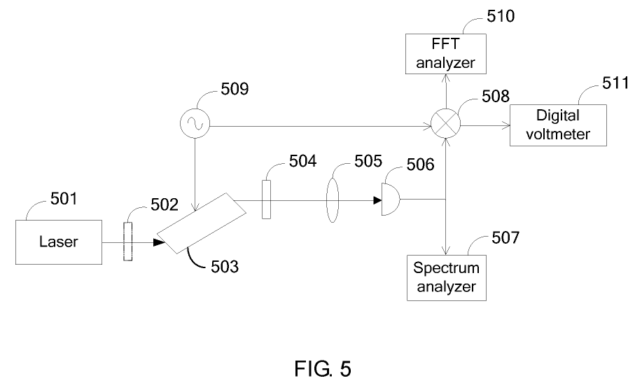

With reference to an embodiment as shown in FIG. 5, a process of the electro-optical phase modulation system reducing residual amplitude modulation will be described hereunder in detail by taking an example where the electro-optical crystal is a lithium niobate crystal.

FIG. 5 is a schematic structural diagram of a system for detecting residual amplitude modulation according to the present invention; specifically, reference may be made to FIG. 5.

Assuming that the electro-optical crystal in the system is a lithium niobate crystal, where the lithium niobate crystal has a length of 50 mm, and the lithium niobate crystal has a height (the height between the upper electrode surface and the lower electrode surface) of d=5 mm, a first portion of the upper electrode surface and a second portion of the lower electrode surface of the lithium niobate crystal have a length of l=45.5 mm, where the first portion is aligned with the second portion, then conducting films are coated on the first portion of the upper electrode surface and the second portion of the lower electrode surface; assuming that the electro-optical crystal has an electro-optical coefficient of γ=31 pm/V, assuming that a beam emitted from a laser has a wavelength of λ=1550 nm, and the electro-optical crystal has a refractive index of n=2.21; it could be obtained from the above parameters that the lithium niobate crystal has a half-wave voltage of

$$V = \frac{λ d}{{n}^{3} γ l} = 509 V .$$

During practical use, a boost circuit can be added in the system to reduce the output voltage of the radio frequency circuit; for instance, a 20-fold boost circuit is added in the system, which could allow the output voltage of the radio frequency circuit to be reduced to 25 V.

Turn on a radio frequency circuit 509 to enable the radio frequency circuit 509 to generate an electric field between an upper electrode surface and a lower electrode surface of an electro-optical crystal 503; linearly polarized light is obtained after a beam emitted from a laser 501 passes through a polarizer 502; after passing through the electro-optical crystal 503, the linearly polarized light then passes through a polarizer 504, and then passes through a lens 505 to enter a detector 506; the output voltage of the detector 506 is divided into two: one enters a spectrum analyzer 507, and the spectrum analyzer 507 measures residual amplitude modulation; the other enters a frequency mixer 508, the frequency mixer 508 mixes the obtained voltage signal with a reference signal generated by the radio frequency circuit 509 to obtain an error signal of the residual amplitude modulation, and transmits the error signal to an FFT analyzer 510 and a digital voltmeter 511; the FFT analyzer 510 and the digital voltmeter 511 measures stability of the error signal of the residual amplitude modulation.

The residual amplitude modulation measured by the spectrum analyzer is approximately 1.3×10⁻⁵, which is decreased by two orders of magnitude in comparison with residual amplitude modulation (10⁻³) generated by a conventional electro-optical modulator.

The stability of the residual amplitude modulation as measured by the FFT analyzer and the digital voltmeter is as follows: 1-second stability of the residual amplitude modulation is decreased by 8 times, and 10-second stability is decreased by 50 times; a noise power spectrum density measured by the FFT analyzer is at 1 Hz, and the noise of the above system is decreased by 30 times in comparison with a conventional electro-optical modulator.

Finally, it should be noted that the foregoing embodiments are merely intended for describing technical solutions of the present invention rather than limiting the present invention. Although the present invention is described in detail with reference to the foregoing embodiments, persons of ordinary skill in the art should understand that they may still make modifications to the technical solutions described in the foregoing embodiments, or make equivalent replacements to some or all technical features therein; however, these modifications or replacements do not make the essence of corresponding technical solutions depart from the scope of the technical solutions in the embodiments of the present invention.

What is claimed is:

1. An electro-optical phase modulation system, comprising: an electro-optical crystal, a radio frequency circuit and a light source, wherein,
a light incident surface of the electro-optical crystal is in parallel with a light exit surface thereof, an upper electrode surface of the electro-optical crystal is in parallel with and facing a lower electrode surface thereof, the light incident surface and the light exit surface are located between the upper electrode surface and the lower electrode surface, and an angle between the light incident surface and the upper electrode surface is a Brewster angle;
two electrodes of the radio frequency circuit are connected to the upper electrode surface and the lower electrode surface respectively, for transmitting radio frequency signals to the upper electrode surface and the lower electrode surface, so that an electric filed, of which a direction is perpendicular to the upper electrode surface, is formed between the upper electrode surface and the lower electrode surface;
the light source is located at a side of the light incident surface, and an incidence angle of a beam emitted from the light source with respect to the light incident surface is the Brewster angle.

2. The system according to claim 1, wherein a first cross section of the electro-optical crystal is in parallel with a second cross section thereof, the first cross section and the second cross section are located between the upper electrode surface and the lower electrode surface and between the light incident surface and the light exit surface, the first cross section is perpendicular to the upper electrode surface, and the first cross section is perpendicular to the light incident surface.

3. The system according to claim 1, wherein the system further comprises a polarizer, wherein the polarizer is located between the light source and the electro-optical crystal, for adjusting the beam emitted from the light source into polarized light.

4. The system according to claim 1, further comprising an angle detecting apparatus, wherein the angle detecting apparatus is configured to detect an angle between the beam emitted from the light source and the light incident surface, and display the detected angle, so that a user regulates a position of the light source or a position of the electro-optical crystal according to the detected angle and the Brewster angle.

5. The system according to claim 1, wherein conducting films are coated on a first portion of the upper electrode surface and a second portion of the low electrode surface, respectively, and the first portion is aligned with the second portion, so that the electric field, of which the direction is perpendicular to the upper electrode surface, is formed between the upper electrode surface and the lower electrode surface.

6. The system according to claim 1, wherein the light source is a laser.

7. The system according to claim 1, wherein the electro-optical crystal is one of a lithium niobate crystal, a magnesium-doped lithium niobate crystal and a potassium titanyl phosphate crystal.

8. The system according to claim 2, wherein conducting films are coated on a first portion of the upper electrode surface and a second portion of the low electrode surface, respectively, and the first portion is aligned with the second portion, so that the electric field, of which the direction is perpendicular to the upper electrode surface, is formed between the upper electrode surface and the lower electrode surface.

9. The system according to claim 2, wherein the light source is a laser.

10. The system according to claim 2, wherein the electro-optical crystal is one of a lithium niobate crystal, a magnesium-doped lithium niobate crystal and a potassium titanyl phosphate crystal.

11. The system according to claim 3, wherein conducting films are coated on a first portion of the upper electrode surface and a second portion of the low electrode surface, respectively, and the first portion is aligned with the second portion, so that the electric field, of which the direction is perpendicular to the upper electrode surface, is formed between the upper electrode surface and the lower electrode surface.

12. The system according to claim 3, wherein the light source is a laser.

13. The system according to claim 3, wherein the electro-optical crystal is one of a lithium niobate crystal, a magnesium-doped lithium niobate crystal and a potassium titanyl phosphate crystal.

14. The system according to claim 4, wherein conducting films are coated on a first portion of the upper electrode surface and a second portion of the low electrode surface, respectively, and the first portion is aligned with the second portion, so that the electric field, of which the direction is perpendicular to the upper electrode surface, is formed between the upper electrode surface and the lower electrode surface.

15. The system according to claim 4, wherein the light source is a laser.

16. The system according to claim 4, wherein the electro-optical crystal is one of a lithium niobate crystal, a magnesium-doped lithium niobate crystal and a potassium titanyl phosphate crystal.
